(19) United States
(12) Patent Application Publication
(10) Pub. No.: US 2021/0409289 A1
(43) Pub. Date: Dec. 30, 2021

(54) MONITORING AND MAINTENANCE METHOD, MONITORING AND MAINTENANCE DEVICE, AND MONITORING AND MAINTENANCE PROGRAM

(71) Applicant: Nippon Telegraph and Telephone Corporation, Tokyo (JP)

(72) Inventors: Kyoko YAMAGOE, Tokyo (JP); Atsushi TAKADA, Tokyo (JP); Motomu NAKAJIMA, Tokyo (JP); Yuji SOEJIMA, Tokyo (JP)

(21) Appl. No.: 17/290,380

(22) PCT Filed: Oct. 18, 2019
(86) PCT No.: PCT/JP2019/041052

§ 371 Date: Apr. 30, 2021

(30) Foreign Application Priority Data
Nov. 2, 2018 (JP) 2018-207325

(51) Int. Cl. H04L 12/24

(52) U.S. Cl. CPC H04L 41/5006; H04L 41/5067; H04L 41/5022; H04L 41/5012

(57) ABSTRACT

The operator load is reduced while satisfying a service quality specification as far as possible. A handling procedure inquiry unit 121 acquires a handling procedure group including at least one handling procedure regarding a failure, a handling/recovery influence inquiry unit 122 acquires a degree of influence of performing, with respect to each handling procedure of the handling procedure group, the handling procedure, a handling procedure prioritization unit 123 selects the handling procedure to be performed based on whether or not a worker is needed and the degree of influence, a countermeasure selection unit 124 assigns the selected handling procedure to an automatic handling control unit 13, a planned maintenance control unit 14, or an immediate action control unit 15 that can perform the handling procedure.

### TECHNICAL FIELD

The present invention relates to a technique for monitoring and maintaining a service.

### BACKGROUND ART

A service provider enters into an SLA (Service Level Agreement) with a user, and assures the service quality based on the SLA. When the SLA is violated, the service provider compensates the user by reducing the fee or the like.

NPLs 1 and 2 propose a technique for reducing a maintenance operation considering the SLA.

### CITATION LIST

### Non Patent Literature

[NPL 1] Chihiro Maru, Naoyuki Tanji, Atsushi Takada, and Kyoko Yamagoe “SLA ni Motozuku Sâbisu Kaihuku Syuhou no Hyouka Houhou (Evaluation method of service recovery method based on SLA)”, 2018 Society Conference, IEICE, B-14-17.

[NPL 2] Atsushi Takada, Chihiro Maru, Naoyuki Tanji, and Kyoko Yamagoe “SLA wo Kouryosita Zyoutyou Souti no Kosyou Taiou Youhi Kettei Syudan (Method of determining whether or not handling of failure of redundancy apparatus is required considering SLA”, 2018 Society Conference, IEICE, B-14-16.

### SUMMARY OF THE INVENTION

### Technical Problem

A service provider constructs a maintenance structure for 24 hours 365 days in order to assure service quality. If a maintenance structure of the same scale of that on a weekday daytime is maintained on weekday nights, Saturdays, Sundays, and national holidays as well, a labor cost and the like are incurred, and the running cost increases. If an automatic handling is possible without depending on a person, or if handling can be performed on a weekday daytime, not on a weekday night, Saturday, Sunday, or a national holiday when the cost is high, even if handling is performed by a person, the running cost can further be reduced. It is conceivable that if an item that can be automatically handled is automatically handled, and an item that can be handled on a weekday daytime is handled on a weekday daytime, and immediate actions are taken with respect to the other items, the operator load can be reduced.

However, when a countermeasure is selected, a viewpoint of service quality assurance is needed in addition to a viewpoint of running cost.

In view of this kind of background, the present invention aims to reduce an operator load while satisfying the service quality specification as far as possible.

### Means for Solving the Problem

A monitoring and maintenance method according to a present invention is a monitoring and maintenance method, to be executed by a computer, of monitoring a service regarding which a service quality specification is specified, and of assigning a countermeasure from among an automatic handling for automatically handling a failure without needing a worker, a planned maintenance for a worker handling a failure in a predetermined time slot, and an immediate action for a worker immediately handling a failure, the monitoring and maintenance method including: acquiring a handling procedure group including at least one handling procedure regarding a failure; acquiring, with respect to each handling procedure of the handling procedure group, a degree of influence of performing the handling procedure; selecting a handling procedure to be performed based on whether or not a worker is needed and the degree of influence; and assigning the selected handling procedure to a performable countermeasure based on a handling deadline regarding the service quality specification.

A monitoring and maintenance apparatus according to the present invention is a monitoring and maintenance apparatus that monitors a service regarding which a service quality specification is specified, and assigns a countermeasure from among an automatic handling for automatically handling a failure without needing a worker, a planned maintenance for a worker handling a failure in a predetermined time slot, and an immediate action for a worker immediately handling a failure, the monitoring and maintenance apparatus comprising: a handling procedure acquisition unit configured to acquire a handling procedure group including at least one handling procedure regarding a failure; a handling influence acquisition unit configured to acquire, with respect to each handling procedure of the handling procedure group, a degree of influence of performing the handling procedure; a handling procedure selection unit configured to select a handling procedure to be performed based on whether or not a worker is needed and the degree of influence; and a countermeasure selection unit configured to assign the selected handling procedure to a performable countermeasure based on a handling deadline regarding the service quality specification.

A monitoring and maintenance program according to the present invention causes a computer to execute the monitoring and maintenance method described above.

### Effects of the Invention

According to the present invention, the operator load can be reduced while satisfying a service quality specification as far as possible.

### BRIEF DESCRIPTION OF DRAWINGS

FIG. 1 is an overall configuration diagram including a monitoring and maintenance apparatus of the present embodiment.

FIG. 2 is a functional block diagram illustrating a configuration of a handling procedure selection unit.

FIG. 3 is a flowchart illustrating a processing flow of the monitoring and maintenance apparatus of the present embodiment.

FIG. 4 is a sequence diagram illustrating a processing flow until the influence to a service is determined when a service alarm and a resource alarm are generated at the same time.

FIG. 5 is a sequence diagram illustrating a processing flow for selecting a countermeasure according to the handling procedure.

FIG. 6 is a sequence diagram illustrating a processing flow when, although an immediate action is selected as the handling procedure, there is no available operation, and as a result, subsequent automatic handling determination is performed.

### DESCRIPTION OF EMBODIMENTS

Hereinafter, a mode for implementing the present invention will be described with reference to the drawings.

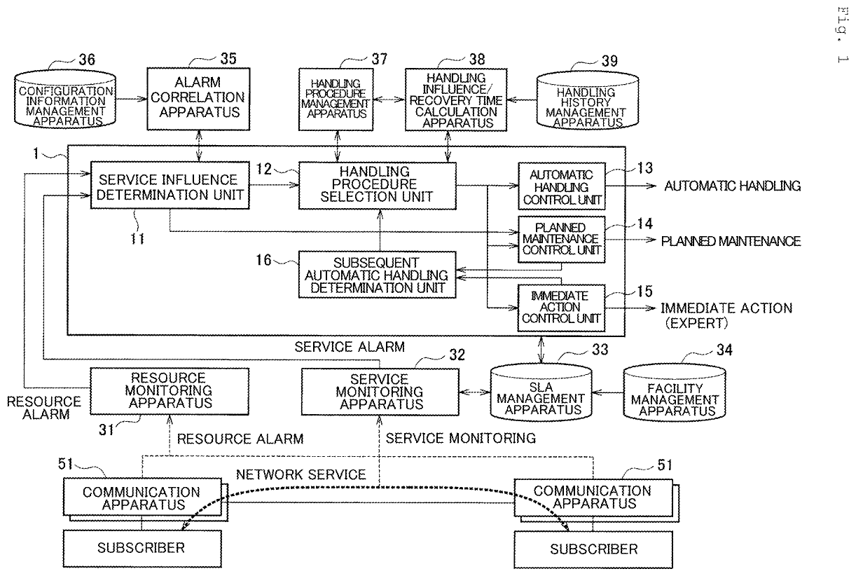

FIG. 1 is an overall configuration diagram including a monitoring and maintenance apparatus of the present embodiment. The monitoring and maintenance apparatus 1 is an apparatus that monitors and maintains a network service that is provided to a subscriber, on a network constructed by a communication apparatus 51 such as a router or a switch. A virtualized network constructed using NFV (Network Functions Virtualization) and a network service provided on the virtualized network may be monitored.

A resource monitoring apparatus 31 monitors the states of resources such as the communication apparatus 51. The resource monitoring apparatus 31, upon detecting an anomaly of the communication apparatus 51, transmits a resource alarm to the monitoring and maintenance apparatus 1. The resource monitoring apparatus 31 detects an anomaly of the communication apparatus 51 using SNMP (Simple Network Management Protocol) and Streaming Telemetry, for example.

The service monitoring apparatus 32 monitors/estimates a service quality maintaining condition for each unit regarding which service quality is specified (e.g., for each user, for each apparatus, for each line, or the like), evaluates the condition by comparing with the service quality specification retained by an SLA management apparatus 33, and detects a service quality specification violation/possible violation. The service monitoring apparatus 32, upon detecting a service quality specification violation/possible violation, transmits a service alarm to the monitoring and maintenance apparatus 1. The service monitoring apparatus 32 monitors the network service quality by measuring the traffic, and applying a test traffic, for example.

The SLA management apparatus 33 retains a service quality specification item and a quality specification range (e.g., a continuous value or an integer value range) for each unit regarding which the service quality is specified. For example, as the service quality specification, a specification regarding the reliability such as an operation rate, an MTTF (Mean Time To Failure), and an MTTR (Mean Time To Repair), and a specification regarding the performance such as a throughput, a delay, a jitter, and a loss are envisioned. A specific example of the service quality specification includes a specification, regarding the service availability, in which the ratio of normal operation time out of one month of operating time (e.g., 720 hours) is assured to be 99.5%, and the like. The service quality specification of the present embodiment includes the specification specified as the quality standard by the service operator agent based on the concept of service quality assurance contract (SLA) in which a quality index and a target value are agreed upon associated with the service contract. Specifically, even if an SLA that is agreed upon with a customer is not present, if the quality standard determined by the service operator agent is present, the quality standard is taken as the SLA. The service quality specification determined by the service operator agent is not a contract with a customer, and therefore, even if a violation occurs regarding the specification, a penalty is not incurred. The SLA management apparatus 33, in response to an inquiry regarding the service quality specification, makes a reply with the specification itself and a violation level. Several stages may be set regarding the violation level.

A facility management apparatus 34 retains information such as a facility, an accommodated user, a contract service, presence or absence of an important line.

The monitoring and maintenance apparatus 1, upon receiving a resource alarm or a service alarm from the resource monitoring apparatus 31 and the service monitoring apparatus 32, specifies the incident (service interruption or an event that incurs quality degradation) from the received alarm, selects a countermeasure with which the operator load is minimized in the range of the service quality specification, and handles the failure. The countermeasures include an automatic handling, a planned maintenance, and an immediate action. The automatic handling is a countermeasure that does not require a worker and in which restarting of an apparatus, service restarting, or the like is automatically performed. The planned maintenance is a countermeasure that is performed by a worker in a determined normal work time such as a weekday daytime. The immediate action is a countermeasure in which an experienced worker (expert) immediately deals with the incident regardless of whether it is night or daytime. In general, the maintenance cost increases in the order of the automatic handling, the planned maintenance, and the immediate action.

The monitoring and maintenance apparatus 1 includes a service influence determination unit 11, a handling procedure selection unit 12, an automatic handling control unit 13, a planned maintenance control unit 14, an immediate action control unit 15, and a subsequent automatic handling determination unit 16.

The service influence determination unit 11 receives a resource alarm and a service alarm, and inquires of an alarm correlation apparatus 35 the incident related to the received alarm. The service influence determination unit 11, upon determining that, from the result of inquiry to the alarm correlation apparatus 35, the service is not influenced, selects the planned maintenance as the handling of the incident.

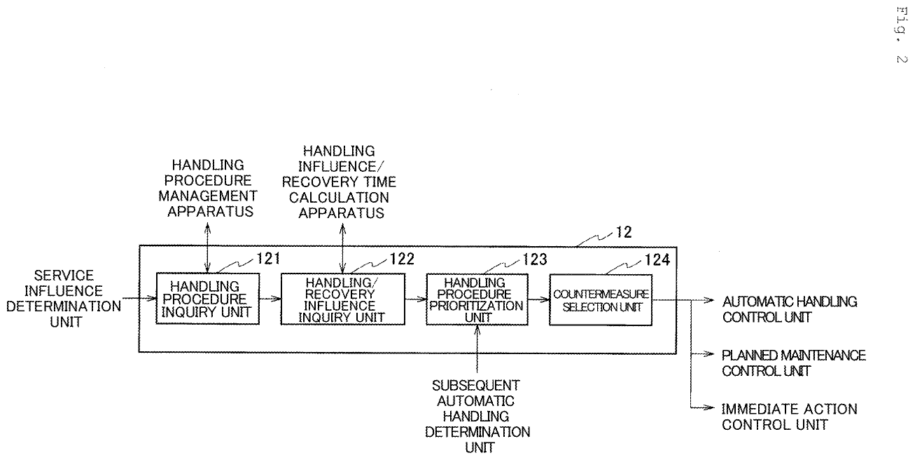

The handling procedure selection unit 12 extracts a handling procedure group with respect to the incident, selects the handling procedure by prioritizing the handling procedures from the viewpoint of the service quality specification and the maintenance cost, and one of the automatic handling, the planned maintenance, and the immediate action is selected as the handling procedure. As shown in FIG. 2, the handling procedure selection unit 12 includes a handling procedure inquiry unit 121, a handling/recovery influence inquiry unit 122, a handling procedure prioritization unit 123, and a countermeasure selection unit 124.

The handling procedure inquiry unit 121 inquires of the handling procedure management apparatus 37 the handling procedure with respect to the incident. If a plurality of handling procedures are present, the handling procedure management apparatus 37 sends the plurality of handling procedures as the reply. The handling procedure includes the details of the handling procedure, and includes information regarding whether or not an on-site action is needed (whether or not a worker is needed) and whether or not an automatic execution is possible.

The handling/recovery influence inquiry unit 122 inquires of the handling influence/recovery time calculation apparatus 38 the degree of influence of performing the handling procedure, for each handling procedure. The degree of influence of performing a handling procedure is the likelihood of service/resource recovery, the handling influence, and the recovery time, when the handling procedure is performed. The likelihood of the service/resource recovery is a recovery rate of the service/resource obtained from the result of performing the handling procedure in the past. The handling influence is an influence such as a service interruption and quality degradation caused by performing the handling procedure. For example, when a handling of restarting an apparatus is performed, the services accommodated in the apparatus are interrupted for a certain time. Therefore, when an apparatus is restarted in order to handle a service influenced by a failure, an influence may be exerted to another service that is accommodated in the same apparatus and is not influenced by the failure. The recovery time is a time needed for recovery from a service interruption and quality degradation. For example, if a plurality of services request authentication for service recovery at the same time after an apparatus is restarted, the waiting time for authentication is included in the recovery time.

The handling procedure prioritization unit 123 prioritizes each handling procedure based on whether or not an on-site action is needed and the degree of influence of performing the handling procedure. For example, a procedure that does not require an on-site action, a procedure regarding which the degree of influence of handling/recovery is in a range in which an automatic execution is possible, a procedure regarding which service recovery likelihood is high, a procedure regarding which a handling influence is small, and a procedure regarding which a recovery time is small are given higher priorities. The handling procedure that causes the service quality specification to be no longer satisfied by being performed may be removed from the procedures to be performed or given a low priority. For example, if the recovery time is long and the service quality specification is violated when performing a handling procedure, the priority of the handling procedure is lowered. The handling procedure prioritization unit 123 may overwrite the information, of the handling procedure, regarding whether or not an automatic execution is possible in accordance with the estimation result of a handling influence and a recovery time. For example, if the degree of influence of handling/recovery is not in a range in which an automatic execution is possible, the handling procedure is not allowed to be automatically executed.

The countermeasure selection unit 124 extracts a handling procedure having the highest priority, and selects the countermeasure for executing the extracted handling procedure. The countermeasure selection unit 124 selects the automatic execution with respect to a handling procedure regarding which on-site action is not required and the degree of influence of handling/recovery is in a range in which automatic execution is possible, selects the planned maintenance with respect to a handling procedure regarding which there is an enough time until the handling deadline, and selects the immediate action with respect to the other handling procedures.

The automatic handling control unit 13 executes a series of processing in accordance with the handling procedure regarding which the automatic execution is selected. For example, processing such as service stopping processing, restarting processing of the communication apparatus 51, service restarting processing, and the like is executed. When a network service is provided in a virtualized network, if the service quality specification regarding the performance is violated or is possibly violated, the automatic handling control unit 13 may dynamically configure/control the virtualized network. As a result of dynamically configuring/controlling the virtualized network, the service quality specification can be observed.

The planned maintenance control unit 14 selects, in order to perform the handling procedure regarding which the planned maintenance is selected, a time slot and a work method (planning, addition to an existing plan) so as to minimize the operation load in a range in which the service quality specification is not violated, and creates a maintenance plan. For example, the planned maintenance control unit 14 retains, for each worker, information such as a worker ID, a work that can be performed, an area that can be covered, and an available operating time, and assigns a worker that is suitable for performing the handling procedure. If an assignable worker is not present, and the handling procedure cannot be performed, the planned maintenance control unit 14 may notify the subsequent automatic handling determination unit 16 of re-selection of the handling procedure.

The immediate action control unit 15 requests the immediate action to an expert with respect to the handling procedure regarding which the immediate action is selected. For example, the immediate action control unit 15 transmits a message requesting the immediate action to a mobile terminal held by the worker. If an available operation is not present and the immediate action is not possible, the immediate action control unit 15 may notify the subsequent automatic handling determination unit 16 of re-selection of the handling procedure.

If a handling procedure regarding which the planned maintenance or the immediate action is once selected cannot be performed, and there is a risk that the service quality specification violation extends, the subsequent automatic handling determination unit 16 again determines whether or not an automatic handling in which criterion is relaxed is possible. An example of relaxing the criterion includes a case where the criterion regarding the range of the degree of influence of handling/recovery in which an automatic execution is possible is relaxed. A case is included as an example where, if the handling procedure includes a work of restarting the service while a worker confirms a starting up log or the like, the criterion of automatization is relaxed by omitting the confirmation of the log or the like by a worker, and as a result, the automatic execution of the handling procedure is made possible.

The alarm correlation apparatus 35 handles the resource alarm and the service alarm that are received from the service influence determination unit 11 as one incident by bringing together these alarms, specifies a cause alarm and an induced alarm, and derives a resource, a service, and a service quality specification risk that are related to the incident. When a failure occurs in an apparatus, not only the apparatus in which the failure occurs, but also another related apparatus may output an alarm. If a service is influenced by the failure of an apparatus, the service monitoring apparatus 32 outputs a service alarm. The alarm correlation apparatus 35 specifies the cause alarm and the induced alarm by bringing together these alarms.

A configuration information management apparatus 36 manages configuration information in which a resource layer and a service layer can be integrally managed. The alarm correlation apparatus 35 derives the resource and the service related to the incident by referring to the configuration information management apparatus 36.

The handling procedure management apparatus 37 extracts, in response to the inquiry from the handling procedure inquiry unit 121, a handling procedure group that includes at least one handling procedure and the details of each handling procedure based on the information regarding the cause alarm. For example, the handling procedure management apparatus 37 retains a correspondence table in which an alarm, a resource or a service, and a handling procedure are associated, and upon receiving information regarding a resource and a service related to the cause alarm, extracts a corresponding handling procedure.

The handling influence/recovery time calculation apparatus 38 estimates, in response to the inquiry from the handling/recovery influence inquiry unit 122, the likelihood of service/resource recovery, the handling influence to a related service, and a recovery time, with respect to the handling procedure, from the information regarding a service related to the resource that is to be handled. The handling influence/recovery time calculation apparatus 38 may inquire of the SLA management apparatus 33 the service quality specification violation level when the handling procedure is performed based on the estimated handling influence and the recovery time.

A handling history management apparatus 39 retains information regarding a past handling history, and the influence on the entire network when a handling was performed and when communication was restored in association with the recovery. The handling history management apparatus 39 manages the history by associating the handling procedure performed in the past with the resource used for the handling, the recovery result indicating the recovery rate of recovering from a failure as a result of performing the handling procedure, the handling influence incurred by the handling and the handling time, and the recovery time it took until the recovery. The handling influence/recovery time calculation apparatus 38 estimates the handling influence to a related service and the recovery time by referring to the handling history management apparatus 39.

Next, the processing flow of the monitoring and maintenance apparatus of the present embodiment will be described.

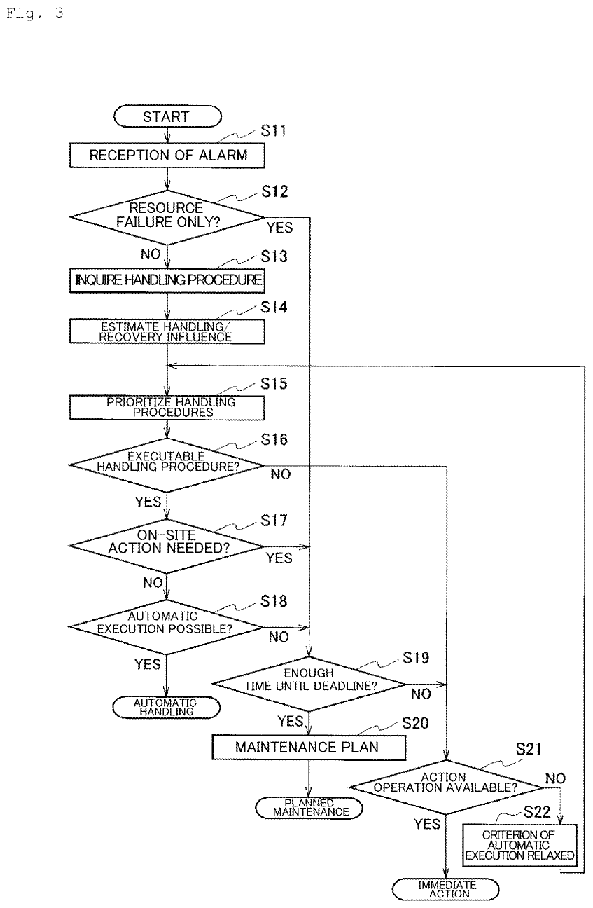

FIG. 3 is a flowchart illustrating the processing flow of the monitoring and maintenance apparatus of the present embodiment.

When the resource monitoring apparatus 31 detects a resource failure and the service monitoring apparatus 32 detects a service quality specification violation/possible violation, a resource alarm and a service alarm are transmitted, and the service influence determination unit 11 receives the resource alarm and the service alarm (step S11).

The service influence determination unit 11 receives an alarm correlation result from the alarm correlation apparatus 35, and derives whether or not an influence to a service is present regarding the incident based on the alarm correlation result (step S12). For example, if the communication apparatus 51 failed, and the service was temporarily interrupted, but the currently used system was switched to a standby system, and the service has already been recovered, only the resource failure is present. If the service is influenced, but the service quality specification is not violated, it may be determined that only the resource failure is present.

If only the resource failure is present (YES in step S12), the processing is advanced to step S19, and a planned maintenance is performed. The processing of step S19 and onward will be described later.

If, not only the resource failure is present, but the service is influenced (NO in step S12), the handling procedure inquiry unit 121 inquires of the handling procedure management apparatus 37 the handling procedure with respect to the incident (step S13).

The handling/recovery influence inquiry unit 122 inquires of the handling influence/recovery time calculation apparatus 38 the handling influence and the recovery time with respect to each of the handling procedures obtained in step S13 (step S14).

The handling procedure prioritization unit 123 prioritizes each handling procedure based on the handling influence, the recovery time, and the like (step S15).

The countermeasure selection unit 124 determines whether an executable handling procedure is present in the descending order of the priority (step S16). It may be determined that a handling procedure with which the service quality specification is no longer satisfied is not executable.

If an executable handling procedure is not present (NO in step S16), the countermeasure selection unit 124 selects the immediate action as the countermeasure, and makes a request to an expert (step S21). In the case where the handling procedure cannot be obtained in step S13 as well, the immediate action may be selected.

If an executable handling procedure is present (YES in step S16), the countermeasure selection unit 124 selects a handling procedure having the highest priority, and determines whether or not an on-site action is needed and whether or not an automatic execution is possible (steps S17 and S18).

If an on-site action is not required (NO in step S17), and an automatic execution is possible (YES in step S18), the countermeasure selection unit 124 selects the automatic handling as the countermeasure, and the automatic handling control unit 13 performs the automatic handling.

If an on-site action is required (YES in step S17), or an automatic execution is not possible (NO in step S18), the countermeasure selection unit 124 determines whether or not an enough time is left until the handling needs to be performed (step S19).

If an enough time is left until the handling needs to be performed (YES in step S19), the countermeasure selection unit 124 makes a maintenance plan, and performs the handling procedure (step S20).

If an enough time is not left until the handling needs to be performed (NO in step S19), the countermeasure selection unit 124 selects the immediate action as the countermeasure, makes a request to an expert, and waits for a request acceptance from the expert (step S21).

If an expert that can perform an action operation is present (YES in step S21), the expert performs the immediate action.

If an expert that can perform the action operation is not present (NO in step S21), the subsequent automatic handling determination unit 16 relaxes the criterion of the automatic execution (step S22), the processing is returned to step S15, and the handling procedures are again prioritized. If the automatic handling is selected as the countermeasure in the processing thereafter, the automatic handling control unit 13 performs the automatic handling.

Next, the processing flow of the entire system including the monitoring and maintenance apparatus of the present embodiment will be described.

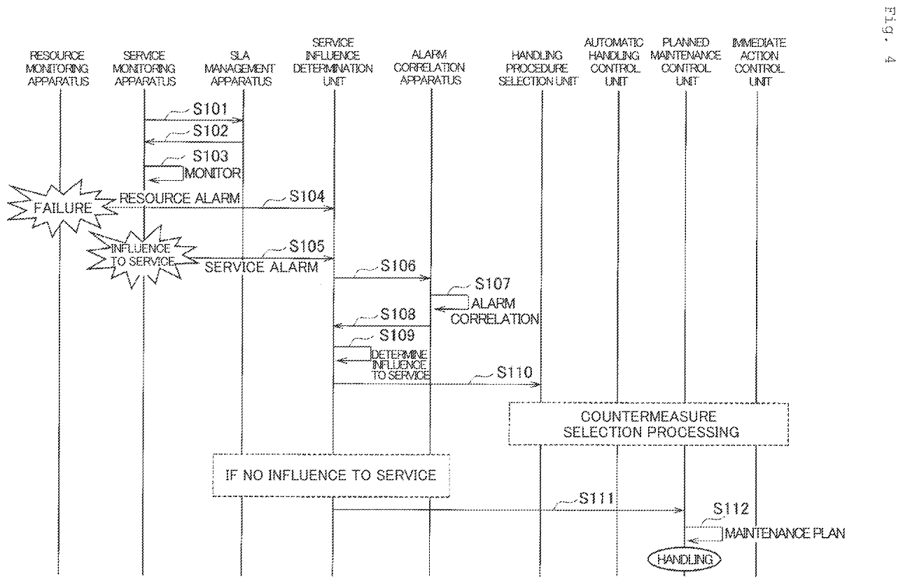

FIG. 4 is a sequence diagram illustrating a processing flow until the influence to a service is determined when a service alarm and a resource alarm are generated at the same time.

The service monitoring apparatus 32 transmits a service ID indicating the service to be monitored to the SLA management apparatus 33 (step S101), and receives a service quality specification such as a service quality specification item, a quality specification range, and a specification violation level from the SLA management apparatus 33 (step S102).

The service monitoring apparatus 32 monitors the network service based on the received service quality specification (step S103).

The resource monitoring apparatus 31, upon detecting a failure of the communication apparatus 51, transmits a resource alarm to the monitoring and maintenance apparatus 1 (step S104). The resource alarm includes failed resource information, a date and time, and alarm information.

If the service is influenced by the failure of the communication apparatus 51, the service monitoring apparatus 32 detects the influence to the service, and transmits a service alarm to the monitoring and maintenance apparatus 1 (step S105). The service alarm includes information regarding a service influenced by the failure, a user that is not influenced by the failure, the specification violation level, and the handling deadline.

The service influence determination unit 11 transmits the received resource alarm and service alarm to the alarm correlation apparatus 35 (step S106).

The alarm correlation apparatus 35 brings together the alarms, and specifies the cause alarm and the induced alarm (step S107).

The alarm correlation apparatus 35 returns an incident ID indicating the incident obtained by brings together the alarms, and a related resource ID/service ID relating to the cause alarm, the induced alarm, and the incident to the service influence determination unit 11 (step S108).

The service influence determination unit 11 determines the influence to the service based on the reply from the alarm correlation apparatus 35 (step S109).

If a service quality specification violation/possible violation is present, the service influence determination unit 11 notifies the handling procedure selection unit 12 of selection of the countermeasure (step S110). The processing of the selection of the countermeasure and onward will be described later.

If a service quality specification violation/possible violation is not present, the service influence determination unit 11 notifies the planned maintenance control unit 14 of the incident ID, the handling deadline, the cause alarm, and the related resource ID (step S111).

The planned maintenance control unit 14 creates a maintenance plan by determining an action date and time, a target resource, and action work contents, and performs the handling procedure (step S112).

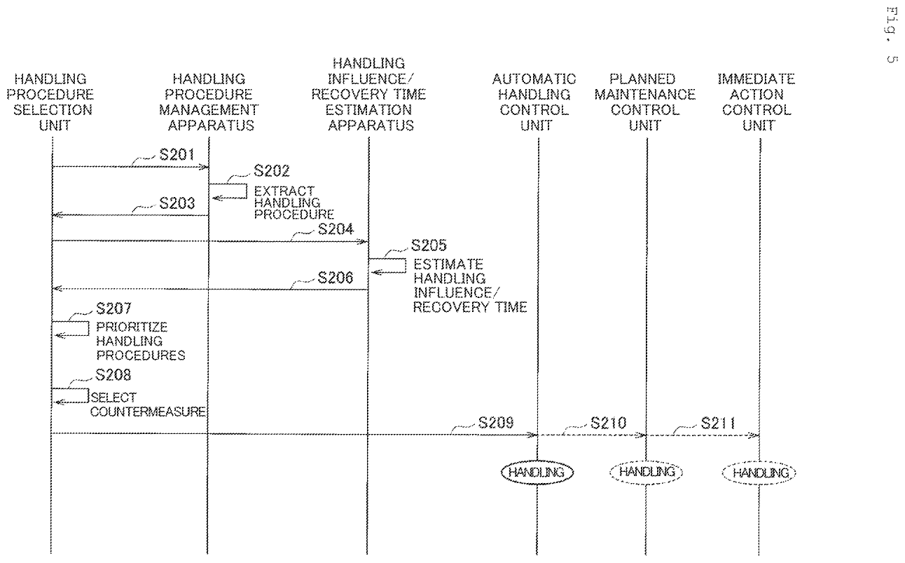

FIG. 5 is a sequence diagram illustrating the processing flow for selecting countermeasure according to the handling procedure.

The handling procedure selection unit 12, upon receiving a notification of selecting the countermeasure due to a service being influenced, inquires the handling procedure by transmitting the incident ID, the cause alarm, the induced alarm, and the related resource ID/service ID to the handling procedure management apparatus 37 (step S201).

The handling procedure management apparatus 37 extracts a corresponding handling procedure based on the received information such as the cause alarm (step S202), and returns the incident ID, a handling procedure ID indicating the extracted handling procedure, information regarding whether or not an on-site action is required and whether or not an automatic execution is possible to the handling procedure selection unit 12 (step S203).

The handling procedure selection unit 12 makes an inquiry regarding the handling influence and the recovery time by transmitting the incident ID, the handling procedure ID, and the related resource ID/service ID to the handling influence/recovery time calculation apparatus 38 (step S204).

The handling influence/recovery time calculation apparatus 38 estimates the handling influence, the recovery time, and the like based on the received information regarding the handling procedure (step S205), and returns the incident ID, the likelihood of service/resource recovery, the handling influence, and the recovery time to the handling procedure selection unit 12 (step S206).

The handling procedure selection unit 12 prioritizes each handling procedure based on the information received from the handling influence/recovery time calculation apparatus 38 (step S207). For example, a handling procedure regarding which an on-site action is not required, an automatic execution is possible, the service recovery likelihood is high, the handling influence is small, and the recovery time is small is prioritized.

The handling procedure selection unit 12 selects a countermeasure for performing the handling procedure with which the service quality specification is satisfied and that has the highest priority (step S208). Specifically, the automatic handling is selected with respect to a handling procedure regarding which an on-site action is not required and an automatic execution is possible, the planned maintenance is selected with respect to a handling procedure regarding which there is enough time until the handling deadline, and the immediate action is selected with respect to a handling procedure other than the above-described handling procedures.

The handling procedure selection unit 12 transmits the incident ID, the handling procedure ID, the handling deadline, and the related resource ID/service ID to the countermeasure selected in step 5208 (one of steps S209, 5210, and S211).

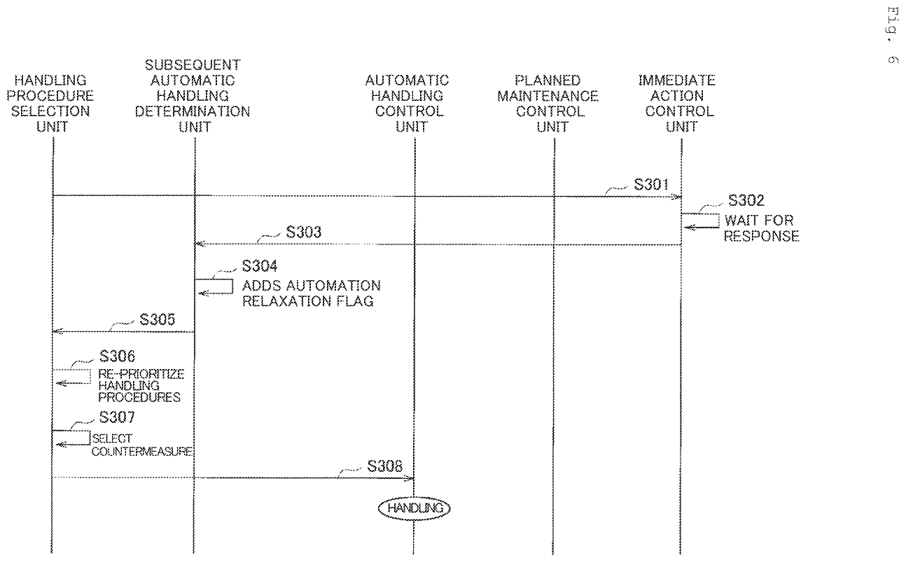

FIG. 6 is a sequence diagram illustrating a processing flow when, although an immediate action is selected as the handling procedure, there is no available operation, and as a result, subsequent automatic handling determination is performed.

The handling procedure selection unit 12 transmits the incident ID, the handling procedure ID, the handling deadline, and the related resource ID/service ID to the immediate action control unit 15 (step S301).

The immediate action control unit 15 transmits a request to an expert and waits for a response (step S302).

If the immediate action control unit 15 does not receive a reply from the expert or receives a reply saying that the request cannot be accepted, transmits the incident ID, the handling procedure ID, and the handling deadline to the subsequent automatic handling determination unit 16 (step S303).

The subsequent automatic handling determination unit 16 adds an automation relaxation flag (step S304), and transmits the incident ID, the handling procedure ID, and the automation relaxation flag to the handling procedure selection unit 12 (step S305). The subsequent automatic handling determination unit 16 may, when adding the automation relaxation flag in step 5304, inquire of the SLA management apparatus 33 the specification violation level, and determine whether or not the automation relaxation flag is added according to the inquiry result.

The handling procedure selection unit 12, after relaxing the restriction of the range, of the degree of influence of handling/recovery, in which an automatic execution is possible, prioritizes the handling procedures (step S306).

The handling procedure selection unit 12 selects the countermeasure that performs the handling procedure with which the service quality specification is satisfied and that has the highest priority (step S307).

The handling procedure selection unit 12 transmits the incident ID, the handling procedure ID, the handling deadline, and the related resource ID/service ID to the countermeasure that is selected in step S307 (step S308). Here, it is assumed that the automatic handling is selected, and the automatic handling control unit 13 performs the handling.

As described above, according to the present embodiment, the handling procedure inquiry unit 121 acquires a handling procedure group including at least one handling procedure regarding a failure. Also, the handling/recovery influence inquiry unit 122 acquires, with respect to each handling procedure in the handling procedure group, the degree of influence resulting from performing the handling procedure. Also, the handling procedure prioritization unit 123 selects the handling procedure to be performed based on whether or not a worker is needed and the degree of influence. Also, the countermeasure selection unit 124 assigns the selected handling procedure to the automatic handling control unit 13, the planned maintenance control unit 14, or the immediate action control unit 15 that can perform the handling procedure. Accordingly, the present embodiment can reduce the operator load while satisfying the service quality specification as far as possible.

According to the present embodiment, the service influence determination unit 11 assigns, if the occurred failure will not cause violation of the service quality specification, the handling of the failure to the planned maintenance control unit 14, and as a result, the immediate action operation can be suppressed.

According to the present embodiment, when the handling procedure that is assigned to the planned maintenance control unit 14 or the immediate action control unit 15 cannot be performed, the subsequent automatic handling determination unit 16 relaxes the criterion for determining whether or not an automatic execution is possible, and again selects the handling procedure, and as a result, an automatic handling can be performed considering an available operation.

Note that the configuration may be such that the units included in the monitoring and maintenance apparatus 1 may be configured by a computer including a computation processing apparatus, a storage apparatus, and the like, and the processing of each unit is executed by a program. The program is stored in a storage apparatus included in the monitoring and maintenance apparatus 1, and the program can also be recorded in a recording medium such as a magnetic disk, an optical disk, and a semiconductor memory, or can be provided through a network. The units of the monitoring and maintenance apparatus 1 may be implemented in different apparatuses, or the functions of the apparatuses that the monitoring and maintenance apparatus 1 uses may be implemented in the monitoring and maintenance apparatus 1 itself.

### REFERENCE SIGNS LIST

1 Monitoring and maintenance apparatus

11 Service influence determination unit

12 Handling procedure selection unit

121 Handling procedure inquiry unit

122 Handling/recovery influence inquiry unit

123 Handling procedure prioritization unit

124 Countermeasure selection unit

13 Automatic handling control unit

14 Planned maintenance control unit

15 Immediate action control unit

16 Subsequent automatic handling determination unit

31 Resource monitoring apparatus

32 Service monitoring apparatus

33 SLA management apparatus

34 Facility management apparatus

35 Alarm correlation apparatus

36 Configuration information management apparatus

37 Handling procedure management apparatus

38 Handling influence/recovery time calculation apparatus

39 Handling history management apparatus

1. A monitoring and maintenance method, to be executed by one or more computers, of monitoring a service regarding which a service quality specification is specified, and of assigning a countermeasure from among an automatic handling for automatically handling a failure without needing a worker, a planned maintenance for a worker handling a failure in a predetermined time slot, and an immediate action for a worker immediately handling a failure, the monitoring and maintenance method comprising:
acquiring a handling procedure group including at least one handling procedure regarding a failure;
acquiring, with respect to each handling procedure of the handling procedure group, a degree of influence of performing the handling procedure;
selecting a handling procedure to be performed based on (i) whether or not a worker is needed and (ii) the degree of influence; and
assigning the selected handling procedure to a performable countermeasure based on a handling deadline regarding the service quality specification.

2. The monitoring and maintenance method according to claim 1, further comprising:
detecting a failure by monitoring service quality for each unit regarding which the service quality is specified and
comparing the service quality against the service quality specification.

3. The monitoring and maintenance method according to claim 1, further comprising:
assigning, based on an occurred failure not violating the service quality specification, the planned maintenance for handling the failure.

4. The monitoring and maintenance method according to claim 1, wherein, in the selecting a handling procedure, whether or not automatic execution of a handling procedure is possible is determined based on the degree of influence, and
if a handling procedure assigned to the planned maintenance or the immediate action cannot be performed, the handling procedure is again selected again, after a criterion for determining whether or not automatic execution is possible is relaxed.

5. A monitoring and maintenance apparatus that is configured to monitor a service regarding which a service quality specification is specified, and that is configured to assign a countermeasure from among an automatic handling for automatically handling a failure without needing a worker, a planned maintenance for a worker handling a failure in a predetermined time slot, and an immediate action for a worker immediately handling a failure, the monitoring and maintenance apparatus comprising:
a handling procedure acquisition unit, including one or more computers, configured to acquire a handling procedure group including at least one handling procedure regarding a failure;
a handling influence acquisition unit, including one or more computers, configured to acquire, with respect to each handling procedure of the handling procedure group, a degree of influence of performing the handling procedure;
a handling procedure selection unit, including one or more computers, configured to select a handling procedure to be performed based on (i) whether or not a worker is needed and (ii) the degree of influence; and
a countermeasure selection unit, including one or more computers, configured to assign the selected handling procedure to a performable countermeasure based on a handling deadline regarding the service quality specification.

6. A non-transitory computer readable medium having stored thereon a monitoring and maintenance program for causing a computer to execute operations comprising:
acquiring a handling procedure group including at least one handling procedure regarding a failure;
acquiring, with respect to each handling procedure of the handling procedure group, a degree of influence of performing the handling procedure;
selecting a handling procedure to be performed based on (i) whether or not a worker is needed and (ii) the degree of influence; and
assigning the selected handling procedure to a performable countermeasure based on a handling deadline regarding a service quality specification.

7. The non-transitory computer readable medium according to claim 6, wherein the operations further comprise:
detecting a failure by monitoring service quality for each unit regarding which service quality is specified; and
comparing the service quality against the service quality specification.

8. The non-transitory computer readable medium according to claim 6, wherein the operations further comprise:
assigning, based on an occurred failure not violating the service quality specification, a planned maintenance for handling the failure.

9. The non-transitory computer readable medium according to claim 6, wherein, in the selecting a handling procedure, whether or not automatic execution of a handling procedure is possible is determined based on the degree of influence, and
if a handling procedure assigned to a planned maintenance or an immediate action cannot be performed, the handling procedure is selected again, after a criterion for determining whether or not automatic execution is possible is relaxed.
